(19) United States
(12) Patent Application Publication
(10) Pub. No.: US 2024/0035185 A1
(43) Pub. Date: Feb. 1, 2024

(54) METHOD FOR LOCALLY APPLYING A METAL NANOLAMINATE IN THE REGION OF A WELD SEAM OF A METAL WORKPIECE

(71) Applicant: TECHNISCHE UNIVERSITAT HAMBURG, Hamburg (DE)

(72) Inventors: Marcus P Rutner, Hamburg (DE); Jakob Brunow, Hamburg (DE)

(73) Assignee: TECHNISCHE UNIVERSITAT HAMBURG, Hamburg (DE)

(21) Appl. No.: 18/267,445

(22) PCT Filed: Dec. 15, 2021
(86) PCT No.: PCT/EP2021/085994

§ 371 Date: Jun. 14, 2023

(30) Foreign Application Priority Data
Dec. 15, 2020 (DE) 10 2020 133 581.4

(51) Int. Cl. C25D 5/10; C25D 7/00

(52) U.S. Cl. CPC C25D 5/10; C25D 7/00

(57) ABSTRACT

Method for applying a nanolaminate to a metal workpiece, wherein a coating made of a nanolaminate is applied in a region that is subjected to a notch effect, for example, a weld seam, which nanolaminate consists of a series of at least two metal layers, wherein each metal layer consists of a metal or a metal alloy that differs from the metal or the metal alloy in the adjacent layer.

According to the invention, the method can take place with a batching tank locally and/or in situ.

The present invention relates to a method for applying a nanolaminate to metal workpieces.

Nanolaminates are of particular interest for a plurality of possible practical uses. They combine, for example, high values for strength with simultaneously high ductility and excellent fatigue resistance. Possible uses are aviation and space flight, automotive construction, industrial construction, and metal construction, in which nanolaminates can be used due to their special mechanical properties.

In Stoudt, M. R. et al. “The influence of a multilayered metallic coating on fatigue crack nucleation” International Journal of Fatigue 23 (2001) p. 215-223, the effect of a multilayer metallic coating on the formation of fatigue fractures is examined. The subject matter of the examination is a double-sided threaded pin coated electrolytically with a 5 μm thick, multilayer Cu—Ni layer. It can be seen that the breakage probability sinks for a pin coated in this way.

A piston rod as used in oil production, wherein highly corrosive conditions are present, is known from US 2020/0115998 A1. With regard to the hardness and the durability and the corrosion resistance, a metallic coating is proposed.

A heat and corrosion-resistant galvanic coating for generating high corrosion resistance, in particular at increased temperatures, is known from DE 4009914 A1. In addition, the coating can also be chromatized.

A single-sided method for electrical coating and a corresponding device are known from CN 1546737 A1. The device has a tank to which electrolyte is fed. A plate anode is arranged approximately centrally in the tank. Nanolaminates are not provided here.

The object of the invention is to provide a method for applying nanolaminates to metal workpieces that changes the mechanical properties of the metal workpieces and increases fatigue resistance with simple means.

The object is achieved according to the invention by a method having the features of claim 1. The dependent claims each refer to advantageous embodiments of the invention.

The method according to the invention serves for applying a nanolaminate to a metal workpiece. Preferably, the nanolaminate is to be applied in a region of the workpiece that is subjected to a notch effect. The notch effect occurs when tensile, shear, bending, or torsion stress from cross-section changes, joints, weld seams, or local structural or geometric formations (imperfections) lead to local load peaks, wherein in particular alternate stresses at the notch point can lead to cracks. In the method according to the invention, a series of at least two metallic layers is applied in the region of a weld seam. Each metallic layer consists of a metal or a metal alloy that differs from the metal or the metal alloy in the adjacent layer. The nanolaminate thus consists of an alternating sequence of metallic layers. The particular effect when applying the nanolaminate in the region of the weld seam is explained by the structure of the weld seam. In the region around the weld seam, what is known as a heat-affected zone is present, in which the basic structure of the welded material has changed. The applied nanolaminate also covers the region around the weld seam, meaning nanolaminate also acts on the heat-affected zone along with the weld seam itself. This results in a previously unachieved service life extension due to the subsequent treatment of the weld seam.

According to the invention, the nanolaminate is applied to the workpiece, in particular in the region of a weld seam. It can be seen here that the stress peaks in the notch weld seam can be considerably reduced by applying the nanolaminate, which increases the service life of the workpiece significantly.

In a preferred development, the nanolaminate consists of an alternating series of at least two metallic layers, preferably four or more layers. The nanolaminate is preferably applied to the workpiece in a spatially limited manner, and in particular in regions that are subjected to a notch effect and cyclical stress to a particularly high degree.

Preferably, it is also provided that the nanolaminate is applied galvanically with a single-bath technique. During the galvanic application, the workpiece itself serves as a cathode, so that the metal ions are deposited here forming a thin layer.

Preferably, at least two metals are selected for the nanolaminate from the following group of metals: Iron, nickel, titanium, cobalt, copper, zinc, niobium, tungsten, chromium, manganese, gold, silver, and platinum.

The invention is described in more detail below using an exemplary embodiment.

The invention is explained using the following figures:

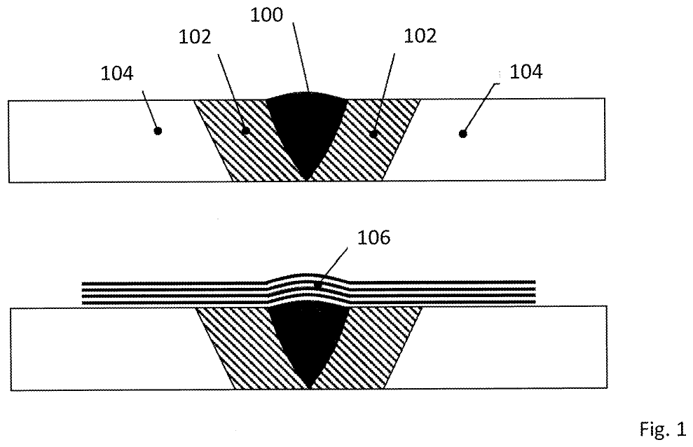

FIG. 1 Structure of a weld seam in cross-section, and

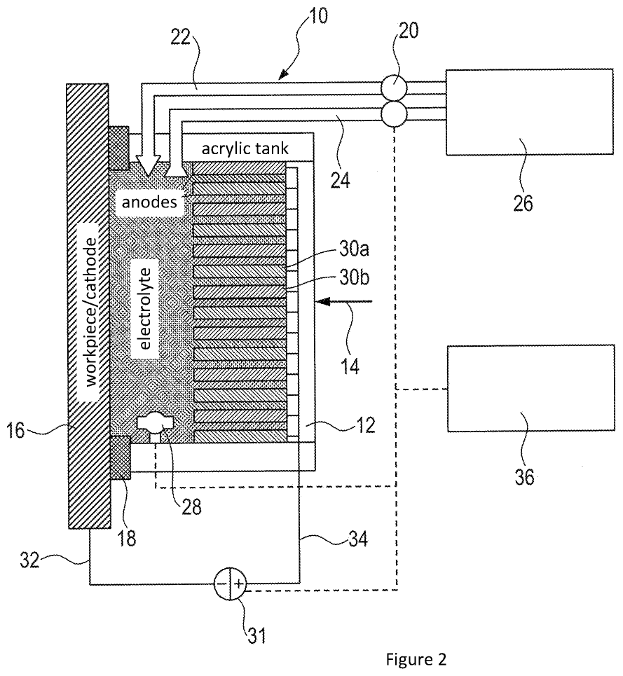

FIG. 2A device for applying the nanolaminate.

FIG. 1 shows the structure of a weld seam in cross-section. The weld seam 100 is shown in black, and what are known as heat-affected zones 102, in which the crystal structure of a base material 104 has changed due to the welding process, are located in the region around the weld seam 100. The base material 104 that is not influenced by the welding process is located further out. In the figure below, the nanolaminate 106 is shown with multiple layers. The layers run from the non-influenced base material 104 over the heat-affected zones 102 to the weld seam itself. This achieves a previously unachieved service life extension for the weld seam.

FIG. 2 shows a device for applying a nanolaminate. Metal constructions that are subjected to cyclical stresses do not fatigue over large surfaces, but instead only in a locally limited way at what are known as critical components or connections. In the building industry, these are divided, for example, into notch classes. A component or connection is then classified as critical when this component or connection leads, as a result of material fatigue, to a particularly short life cycle, which thus also determines the life cycle of the entire construction or of the workpiece. Known methods for treating the surface that lead to an increase in the life cycle are based on seam geometry improvement (sanding/TIG remelting), work hardening (hammering, ultrasonic treatment (UIT/UP), shot peening) of the surface, or generating residual compressive stresses (nitrating, borating, ion implantation). The method presented here does not use any of these methods; instead, it creates an increase in the life cycle with an extremely durable but thin nanolaminate coating. This invention can be additively combined with one of the previously named methods.

In Stoudt, M R, Ricker R E, Cammarata, R C “The Influence of a Multilayered Metallic Coating on Fatigue Crack Nucleation” in International Journal of Fatigue 23 (2001), pages 215 to 223, the effect of a copper-nickel nanolaminate is described, which is applied as a thin layer to copper substrate, which increases service life of the substrate by more than a factor of 100. Five properties of the nanolaminate on the copper substrate were recognized as necessary.

In the method according to the invention, a nanolaminate is applied to metal workpieces to improve the fatigue resistance. The nanolaminate is preferably applied to the workpiece on weld seams and also at joints and/or notches. The coating with the nanolaminate consists of a series of at least two metallic layers that also differ from the metal or the metal alloy in the adjacent layer. For each workpiece, significant notches that limit the service life of the workpiece can be identified. When selecting the location at which the nanolaminate is applied, it is provided according to the invention to apply a nanolaminate as a thin coating to this critical region through galvanic metal deposition in order to increase the fatigue resistance of the entire workpiece many times over. A particular advantage of this method is that it can be performed both on new and on existing constructions.

A galvanic device 10 is provided for applying the nanolaminate. The galvanic device 10 consists of a batching tank 12, which is designed here as a trough-shaped acrylic tank. It must generally be ensured that the batching tank 12 consists of a chemically resistant material, such as acrylic or polypropylene. The batching tank 12 is pressed with a pressing force 14 onto the workpiece 16. The edge of the batching tank 12 has a seal 18 in the exemplary embodiment. It is also possible to additionally or exclusively provide a seal from the outside in order to seal the interior of the batching tank, for example, using sealing means placed on from the outside.

The batching tank 12 can be supplied with an electrolyte by an electrolyte pump 20 via a feed line 22 and a discharge line 24. An electrolyte reservoir 26 for the electrolyte is provided, in which the electrolyte that is not used in the batching tank 12 can be stored. Preferably, it is also possible to perform a chemical surface preparation for the workpiece 16 using the electrolyte pump 20 and the feed and discharge lines 22, 24. Here, the surface of the workpiece 16 is prepared using a corresponding chemical means so that a nanolaminate can be applied here in the desired manner. In addition, it is also possible to perform a subsequent chemical treatment of the surface with the nanolaminate after applying the nanolaminate. Here, it can also be provided to clean the tank 12. The chemical cleaning of the workpiece or of the batching tank 12 can be supported by an ultrasonic actuator.

The circulation of the electrolyte in the batching tank 12 is supported by a circulating pump 28 or another mechanical stirring device. In this way, the electrolyte is moved and the ion exchange between the anode 30a, 30b and the workpiece 16 as the cathode is supported. In the exemplary embodiment shown, two forms of the anode 30a, 30b are shown schematically. This is a single-bath technique, in which it is provided to establish, dependently of the applied current, which ions from the electrolyte are deposited. The corresponding current or, respectively, the corresponding current pulses are generated by the pulsed current source 31. The pulsed current source 31 is connected in an electrically conductive manner to the workpiece 16 as the cathode via a line 32. The positive pole of the pulsed current source 31 is connected to the anodes 30a, 30b in the batching tank 12 via a line 34. For the connection of the plurality of anodes 30a, 30b, it is preferably provided that they are linked in the batching tank and the pulsed current generator is only connected to a connection that leads out of the tank.

To apply the nanolaminate to the workpiece 16, the galvanic device 10 has a central controller 36 that controls the circulating pump 28, the pulsed current source 31, and the electrolyte pump 20. A preliminary cleaning of the workpiece 16, for example, can take place by means of the central controller. The batching tank 12 is then cleaned and finally filled with electrolyte. The order and the thickness of the layers when applying the nanolaminate can also be influenced by controlling the pulsed current source 31. Preferred process parameters here are, for example, a temperature for the electrolyte of approx. 20° C., wherein, for a copper deposit, a current density of 0.4 to 0.8 mA/cm² is used and for a nickel deposit, a current density of 50 mA/cm² is used. Here, nanolaminates with an area of 10 to 100 cm² can be produced.

### LIST OF REFERENCE SIGNS

10 Galvanic device
12 Batching tank
14 Pressing force
16 Workpiece
18 Seal
20 Electrolyte pump
22 Feed line
24 Discharge line
26 Electrolyte reservoir
28 Circulating pump
30a, b Anodes
31 Pulsed current source
32 Line
34 Line
36 Central controller
100 Weld seam or welding zone
102 Heat-affected zone (HAZ)
104 Non-influenced base material
106 Nanolaminate

1. A method for applying a nanolaminate to a metal workpiece, wherein a coating made of a nanolaminate, which consists of a series of at least two metallic layers, is applied in a spatially limited region, wherein each metallic layer consists of a metal or a metal alloy that differs from the metal or the metal alloy in the adjacent layer, characterized in that the nanolaminate is applied to the workpiece in the region of a weld seam.

2. The method according to claim 1, characterized in that the nanolaminate consists of an alternating series of at least two metallic layers.

3. The method according to claim 1, characterized in that the nanolaminate is applied to the weld seam and in the adjacent heat-affected zone or zones in a spatially limited manner.

4. The method according to claim 1, characterized in that the nanolaminate on the workpiece has four or more metallic layers in the region of the weld seam.

5. The method according to claim 1, characterized in that the nanolaminate is galvanically applied with a single-bath technique or a multi-bath technique.

6. The method according to claim 1, characterized in that at least two metals are selected for the nanolaminate from the following group of metals: Iron, nickel, titanium, cobalt, copper, zinc, niobium, tungsten, chromium, manganese, gold, silver, and platinum.

7. The method according to claim 2, characterized in that the nanolaminate is applied to the weld seam and in the adjacent heat-affected zone or zones in a spatially limited manner.

8. The method according to claim 2, characterized in that the nanolaminate on the workpiece has four or more metallic layers in the region of the weld seam.

9. The method according to claim 3, characterized in that the nanolaminate on the workpiece has four or more metallic layers in the region of the weld seam.

10. The method according to claim 2, characterized in that the nanolaminate is galvanically applied with a single-bath technique or a multi-bath technique.

11. The method according to claim 3, characterized in that the nanolaminate is galvanically applied with a single-bath technique or a multi-bath technique.

12. The method according to claim 4, characterized in that the nanolaminate is galvanically applied with a single-bath technique or a multi-bath technique.

13. The method according to claim 2, characterized in that at least two metals are selected for the nanolaminate from the following group of metals: Iron, nickel, titanium, cobalt, copper, zinc, niobium, tungsten, chromium, manganese, gold, silver, and platinum.

14. The method according to claim 3, characterized in that at least two metals are selected for the nanolaminate from the following group of metals: Iron, nickel, titanium, cobalt, copper, zinc, niobium, tungsten, chromium, manganese, gold, silver, and platinum.

15. The method according to claim 4, characterized in that at least two metals are selected for the nanolaminate from the following group of metals: Iron, nickel, titanium, cobalt, copper, zinc, niobium, tungsten, chromium, manganese, gold, silver, and platinum.

16. The method according to claim 5, characterized in that at least two metals are selected for the nanolaminate from the following group of metals: Iron, nickel, titanium, cobalt, copper, zinc, niobium, tungsten, chromium, manganese, gold, silver, and platinum.
